(19) United States
(12) Patent Application Publication
(10) Pub. No.: US 2025/0367587 A1
(43) Pub. Date: Dec. 4, 2025

(54) A UNIT DESIGN AND PROCESS FOR DIRECT CAPTURE OF CARBON DIOXIDE FROM AIR

(71) Applicant: SHELL USA, INC., Houston, TX (US)

(72) Inventors: Sayee Prasaad BALAJI, Amsterdam (NL); Timothy Michael NISBET, Amsterdam (NL); Ghata Manishkumar NIRMAL, Bangalore North (IN)

(21) Appl. No.: 18/873,760

(22) PCT Filed: Jun. 19, 2023
(86) PCT No.: PCT/EP2023/066404

§ 371 Date: Dec. 11, 2024

(30) Foreign Application Priority Data
Jun. 21, 2022 (EP) 22180015.4

(51) Int. Cl. B01D 53/04; B01D 53/14

(52) U.S. Cl. CPC B01D 53/0407; B01D 53/1475; B01D 2221/16; B01D 2257/504; B01D 2258/06

(57) ABSTRACT

Implementations of the disclosed subject matter provide a process for capture of carbon dioxide from a gaseous feed stream. The process may include a direct air capture unit comprising an inlet air section, a sorbent section, and an outlet air section. A gaseous feed stream may be received at the inlet air section and the feed stream may be contacted with a sorbent material in the sorbent section. An exit gaseous outlet stream may be provided from the outlet air section. The total pressure loss across the inlet and outlet air sections may be maintained at less than 200 Pa. The feed stream may have a volumetric flow within the sorbent section having a maximum and a minimum flow. The unit may include at least one structural element for maintaining the minimum flow to be within a range of 0-20% lower than the maximum flow over the entire sorbent section.

### TECHNICAL FIELD OF THE INVENTION

The present invention relates to a direct air capture (DAC) unit design and process for capturing carbon dioxide (CO₂) from a gaseous feed stream. More specifically the present invention relates to a module design and process for capturing carbon dioxide (CO₂) from a gaseous feed stream, wherein the process may include a direct air capture (DAC) unit comprising an inlet air section, a sorbent section, and an outlet air section. The total pressure loss across the inlet and outlet air sections may be maintained at less than 200 Pa. The gaseous feed stream may have a volumetric flow within the sorbent section and the volumetric flow may have a maximum and a minimum flow. The minimum flow may be maintained to be within a range of 0-20% lower than the maximum flow over the entire sorbent section.

### BACKGROUND

Direct air capture (DAC) of carbon dioxide from the air has been proposed as one way of addressing human induced climate change. Current estimates place global levels of carbon dioxide in the atmosphere at around 420 parts per million. This is expected to rise to around 900 parts per million by the end of the 21st century. Hence, DAC represents one of a range of technologies that can be employed to reduce the environmental impact of greenhouse gases like carbon dioxide and help the transition to a low carbon global economy.

Typical DAC systems take large quantities of air (or other conditioned gaseous atmosphere) which is pumped as a feedstream through a unit that contains a sorbent substance that removes the carbon dioxide from the feedstream. Over time the sorbent becomes loaded with captured carbon dioxide. Next, the captured carbon dioxide in the sorbent is extracted from the sorbent in the regeneration step. Regeneration may involve thermal or chemical processes depending upon the type of sorbent material that is selected for use in the DAC process. Upon regeneration the captured carbon dioxide is released from the sorbent and can be used to manufacture sustainable fuels, chemicals, in food and beverage production or in carbon capture and sequestration (CCS) in order to create a net negative carbon process. The energy input to the DAC system can comprise of thermal energy in the form of steam, and electrical energy for both the absorption (to move the air through the DAC unit) and regeneration (to regenerate the CO₂ from the sorbent) steps.

In general, DAC is a capital intensive process due to the necessity to process a large amount of air. Therefore, the productivity of the DAC unit is highly important in the total cost of CO₂ captured. If the productivity of the DAC unit decreases, then the cost of CO₂ captured will increase. Thus, it is imperative to maintain optimum (high) productivities of the DAC unit so that the cost is minimized.

### BRIEF SUMMARY

According to an embodiment of the disclosed subject matter, a process for capturing carbon dioxide (CO₂) from a gaseous feed stream may include a direct air capture (DAC) unit comprising: an inlet air section, a sorbent section, and an outlet air section. The total pressure loss across the inlet and outlet air sections may be maintained at less than 200 Pa. The gaseous feed stream may have a volumetric flow within the sorbent section and the volumetric flow may have a maximum and a minimum flow. The DAC unit may include at least one structural element for maintaining the minimum flow to be within a range of 0-20% lower than the maximum flow over the entire sorbent section.

Implementations of the disclosed subject matter provide a process for capturing carbon dioxide (CO₂) from a gaseous feed stream using a DAC unit, wherein the gaseous feed stream has an average CO₂ concentration greater than 95% of the CO₂ concentration of ambient air, and wherein the ambient air has any wind direction and any wind speed. The disclosed subject matter allows for improved efficiency and reduced costs in the overall DAC process. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example process and side view according to an implementation of the disclosed subject matter.

FIG. 2 shows an example process and side view according to an implementation of the disclosed subject matter.

FIG. 3 shows an example process and side view according to an embodiment of the disclosed subject matter.

FIG. 4 shows an example process and side view according to an embodiment of the disclosed subject matter.

FIG. 5 shows an example process and side view according to an implementation of the disclosed subject matter.

FIG. 6 shows an example process and side view according to an implementation of the disclosed subject matter.

FIG. 7 shows an example process and side view according to an implementation of the disclosed subject matter.

### DETAILED DESCRIPTION

In general, a problem or disadvantage of the DAC units that are known in the art is a decrease in CO₂ productivity of the module or DAC unit due to uneven distribution of air flow through the unit. The present invention solves this problem by increased CO₂ productivity, leading to lower CO₂ capture cost.

The present invention is a module design for a DAC unit for capturing CO₂ from the air using either a solid or liquid sorbent. During adsorption/absorption, air is flowed through the DAC unit via fans and the air is contacted with the sorbent which then captures the CO₂ from the air. The CO₂ depleted air is vented to the atmosphere at the outlet. Since DAC is a process that may be deployed at a large scale and is subject to fluctuations in the wind speed and direction at a particular location, it is important to prevent uneven distribution of air flow through the unit, whilst maintaining a low pressure drop across of the module. This is because uneven distribution of flow reduces the CO₂ productivity—the present invention solves this problem.

According to an embodiment, the present invention minimizes the ingestion of CO₂ depleted air by the DAC unit by optimizing several design parameters. According to an embodiment, the process for capture of carbon dioxide from a gaseous feed stream, as described herein, may comprise a direct air capture (DAC) unit that may include 1) an inlet air section, 2) a sorbent section, and 3) an outlet air section. The DAC unit may receive a gaseous feed stream at the inlet air section. At least part of the gaseous feed stream may be contacted with a sorbent material located within the sorbent section. An exit gaseous outlet stream may be provided from the outlet air section. The total pressure loss across the inlet and outlet air sections may be maintained at less than 200 Pa. The total pressure loss may be equal to the sum of the static and dynamic pressure losses. Static pressure loss is due to frictional resistance and dynamic pressure loss is due to accelerating and decelerating flow. For example, the total pressure loss may be the sum of the pressure loss in the inlet air section plus the pressure loss in the outlet air section. As a specific example, if the pressure loss within the inlet air section is 75 Pa, the pressure loss within the outlet air section may be maintained to be 125 Pa or less. In this case, the total pressure loss across the inlet and outlet air sections is maintained to be less than 200 Pa, i.e., 75 Pa pressure loss in the inlet air section plus 125 Pa pressure loss in the outlet air section, for a total pressure loss of 200 Pa or less.

The gaseous feed stream may have a volumetric flow within the sorbent section and this volumetric flow may have a maximum flow and a minimum flow. The minimum flow may be maintained to be within a range of 0-20% lower than the maximum flow over the entire sorbent section. For example, if the volumetric flow within the sorbent section has a maximum flow of 25 m³/s, the minimum flow within the sorbent section may be maintained to be within the range of 20-25 m³/s which is within the range of 0-20% lower than the maximum flow of 25 m³/s. According to an embodiment, the DAC unit may include at least one structural element for maintaining the minimum flow to be within a range of 0-20% lower than the maximum flow over the entire sorbent section. The structural element(s) are further described below.

In general, the difference between the minimum flow and maximum flow within the DAC unit should be kept to a minimum as low as possible. In some cases, for example, a DAC unit may be built up from a stack of multiple, individual containers (e.g., sea containers, shipping containers, etc.) and in this case, the DAC unit may comprise internal floors at different levels. In the case where these floors are solid (i.e. impermeable to air flow) in the outlet air section, it is more difficult to minimize the difference between minimum flow and the maximum flow. Instead, it is preferable to have floors with a high open area (i.e. permeable to air flow), for example where the floors are open grating floors, or where there are no floors in the outlet air section. By having floors that are permeable to air flow or no floors, this makes it easier to minimize the difference between minimum flow and the maximum flow within the DAC unit.

According to an embodiment, the process may include a direct air capture (DAC) unit comprising: a first and second inlet faces located on opposite sides of the DAC unit. A sorbent material may be located inside the DAC unit, and at or behind each of the first and second inlet faces. An outlet may be located at the top of the DAC unit and the outlet may provide an exit gaseous outlet stream. The exit gaseous outlet stream may have a flow that is produced by at least one fan. The process may include receiving a gaseous feed stream at the inlet faces, and the gaseous feed stream may have an average CO₂ concentration greater than 95% of the CO₂ concentration of ambient air by minimizing reingestion of the exit gaseous outlet stream which may have any wind direction and any wind speed. According to an embodiment, the DAC unit according to the present invention is designed in such a way that the average concentration of CO₂ at all inlet faces is greater than 95% of the CO₂ concentration of ambient air by minimizing reingestion of the exit gaseous outlet stream for any and all wind directions and wind speeds wherever geographically the DAC unit may be operating.

In an embodiment, the gaseous feed stream may be accelerated one time in the inlet air section and the exit gaseous outlet stream may be accelerated one time in the outlet air section. For example, air can be accelerated in the inlet air section by establishing a reduced pressure in the sorbent section and accelerated in the outlet air section by reducing the area available for the flow This can be achieved by a fan, or by constricting part of the flow path upstream or downstream of a fan.

According to an embodiment, the DAC unit may further comprise at least one structural element for maintaining the minimum flow to be within a range of 0-20% lower than the maximum flow over the entire sorbent section. The at least one structural element may be internal or external to the DAC unit. In an embodiment, the DAC unit may further comprise at least one structural element located in the inlet air section extending from the top of the DAC unit adjacent to at least one of the first and second inlet faces, and the structural element may be either partially or fully impermeable to the gaseous feed stream. A partially impermeable structural unit may be, for example, a screen, a mesh material, a perforated material, a membrane, etc., or any other partially impermeable structure or material. A fully impermeable structural unit may be, for example, any material or structure that is impermeable to the gaseous feed stream and blocks the flow of the gaseous feed stream through the material or structure.

According to an embodiment, the DAC unit may further comprise at least one structural element located in the outlet air section, and the structural element is either partially or fully impermeable to the exit gaseous outlet stream. As described above, a partially impermeable structural unit may be, for example, a screen, a mesh material, a perforated material, a membrane, etc., or any other partially impermeable structure or material. A fully impermeable structural unit may be, for example, any material or structure that is impermeable to the exit gaseous outlet stream and blocks the flow of the exit gaseous outlet stream through the material or structure.

In an embodiment, the structural element may have a length, and the ratio of the length of the structural element to the total height of the DAC unit may be less than 0.3, may be less than 0.2, and may be less than 0.1 The structural element may be located in either the inlet air section or the outlet air section or both. For example, if the total height of the DAC unit is 25 m, the length of the structural element may be less than 7.5 m (ratio of 7.5:25 is 0.3), may be less than 5 m (ratio of 5:25 is 0.2), and may be less than 2.5 m (ratio of 2.5:25 is 0.1).

For the purposes of promoting an understanding of the principles of the invention, reference will now be made to the embodiments illustrated in the accompanying drawings, which are described in more detail below. The embodiments disclosed herein are not intended to be exhaustive or limit the invention to the precise form disclosed in the following detailed description. The invention includes any alterations and further modifications in the illustrated devices and described methods and further applications of the principles of the invention as set forth in the claims.

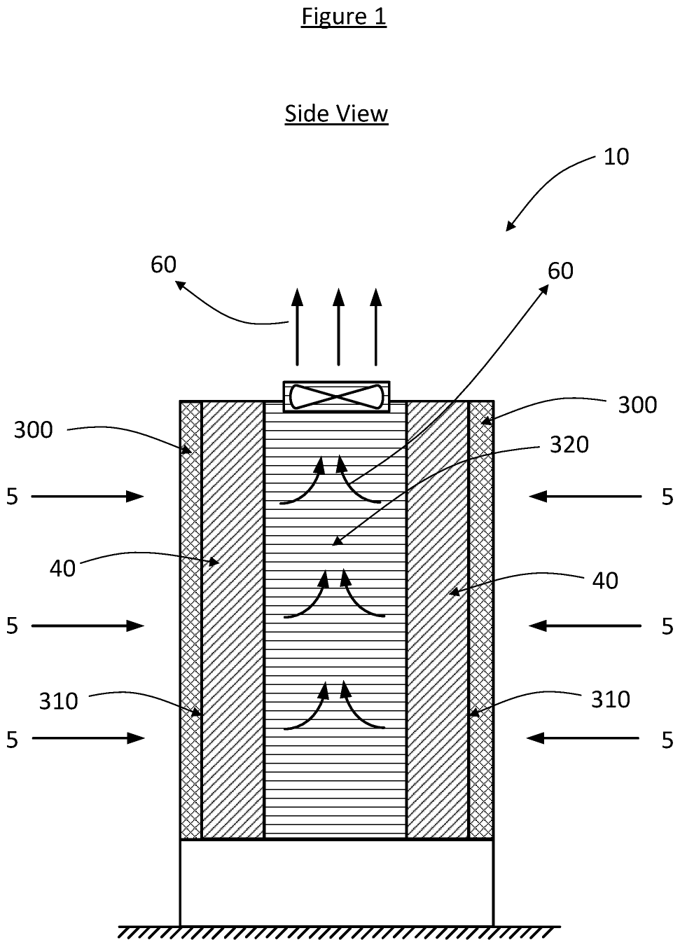

FIG. 1 shows an example process according to an implementation of the disclosed subject matter. In particular, FIG. 1 shows a side view of a DAC unit according to an embodiment of the present invention. As shown in FIG. 1, a process for capture of carbon dioxide from a gaseous feed stream 5 may include a direct air capture (DAC) unit 10. The DAC unit 10 may include an inlet air section 300, a sorbent section 310, and an outlet air section 320. The gaseous feed stream 5 may be received at the inlet air section 300. At least part of the gaseous feed stream 5 may be contacted with a sorbent material 40 that is located within the sorbent section 310. An exit gaseous outlet stream 60 may be provided from the outlet air section 320. Although not given a reference numeral, FIG. 1 also shows a fan and chimney located in the outlet air section 320.

The total pressure loss across the inlet and outlet air sections 300, 320 may be maintained to be less than 200 Pa. In addition, the gaseous feed stream 5 has a volumetric flow within the sorbent section 310, and the volumetric flow may have a maximum flow and a minimum flow. The minimum flow may be maintained to be within a range of 0-20% lower than the maximum flow over the entire sorbent section 310.

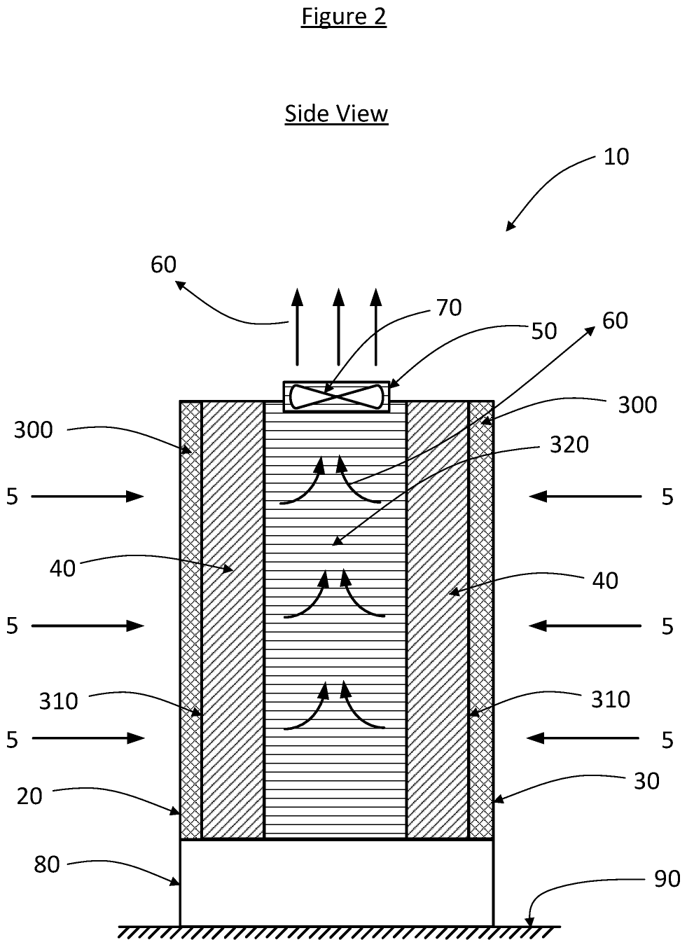

FIG. 2 shows an example process according to an implementation of the disclosed subject matter. In particular, FIG. 2 shows a side view of a DAC unit according to an embodiment of the present invention. As shown in FIG. 2, a process for capture of carbon dioxide from a gaseous feed stream 5 may include a direct air capture (DAC) unit 10. The DAC unit 10 may include an inlet air section 300, a sorbent section 310, and an outlet air section 320. The gaseous feed stream 5 may be received at the inlet air section 300. At least part of the gaseous feed stream 5 may be contacted with a sorbent material 40 that is located within the sorbent section 310. An exit gaseous outlet stream 60 may be provided from the outlet air section 320. Also shown in FIG. 2, the DAC unit 10 may include a void space 80 under the DAC unit 10 separating the DAC unit 10 from the supporting plane 90.

As further shown in FIG. 2, the DAC unit 10 may also include a first inlet face 20 and a second inlet face 30. As shown, the first and second inlet faces 20 and 30 may be on opposite sides of the DAC unit 10 within the inlet air section 300. The sorbent material 40 may be located at or behind each of the first and second inlet faces 20,30. The DAC unit 10 may also include an outlet 50 located at the top of the DAC unit 10 within the outlet air section 320 for providing the exit gaseous outlet stream 60. The exit gaseous outlet stream 60 may have a flow that is produced by at least one fan 70. The gaseous feed stream 5 may be received at each of the first and second inlet faces 20, 30. The gaseous feed stream 5 may have an average CO₂ concentration greater than 95% of the CO₂ concentration of ambient air by minimizing reingestion of the exit gaseous outlet stream, and the ambient air may have any wind direction and any wind speed.

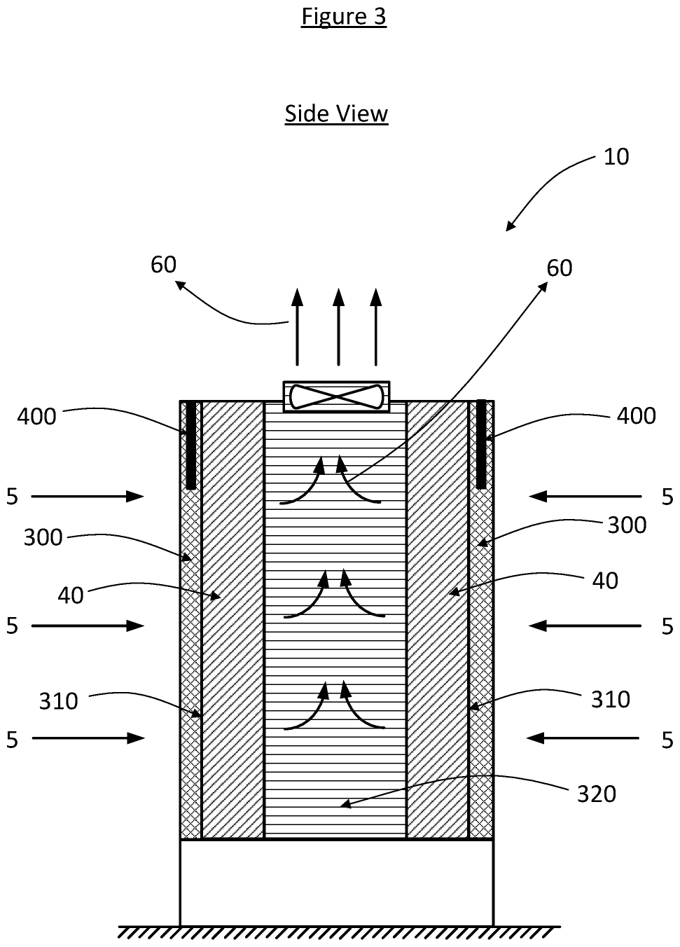

FIG. 3 shows an example process according to an implementation of the disclosed subject matter. In particular, FIG. 3 shows a side view of a DAC unit according to an embodiment of the present invention. As shown in FIG. 3, a process for capture of carbon dioxide from a gaseous feed stream 5 may include a direct air capture (DAC) unit 10. The DAC unit 10 may include an inlet air section 300, a sorbent section 310, and an outlet air section 320. The gaseous feed stream 5 may be received at the inlet air section 300. At least part of the gaseous feed stream 5 may be contacted with a sorbent material 40 that is located within the sorbent section 310. An exit gaseous outlet stream 60 may be provided from the outlet air section 320. Although not shown in FIG. 3, the gaseous feed stream 5 may be accelerated one time in the inlet air section 300 and the exit gaseous outlet stream 60 may be accelerated one time in the outlet air section 320.

As further shown in FIG. 3, the DAC unit may include at least one structural element 400 for maintaining the minimum flow to be within a range of 0-20% lower than the maximum flow over the entire sorbent section 310. As shown in FIG. 3, the DAC unit may include more than one structural element, for example, as shown, the DAC unit 10 may include two or more structural elements 400. According to an embodiment, the structural element 400 may be located within the inlet air section 300. As described above, the structural element 400 may be either partially or fully impermeable to the gaseous feed stream 5.

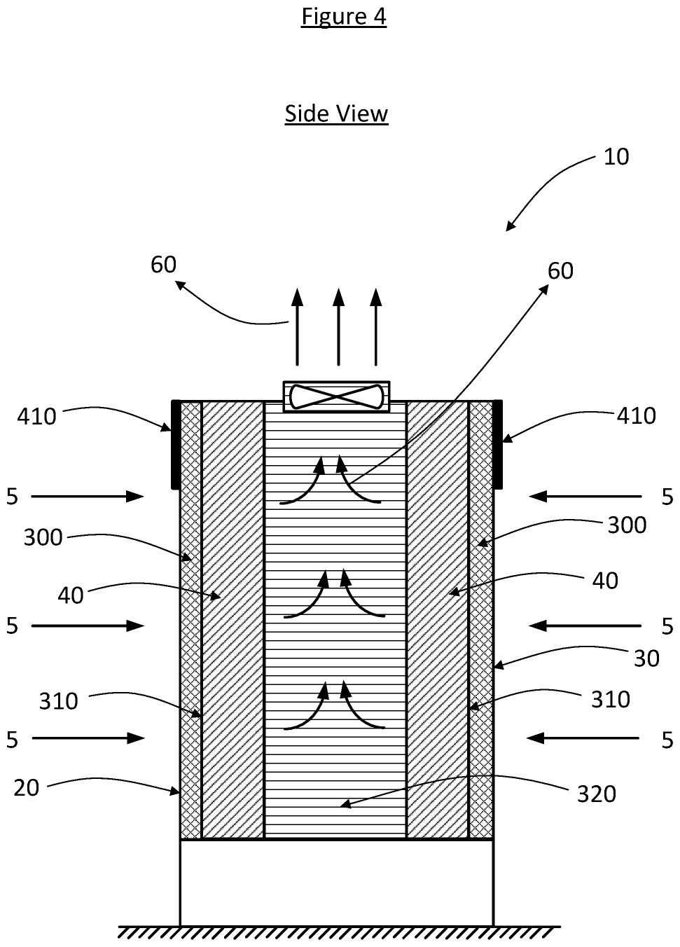

FIG. 4 shows an example process according to an implementation of the disclosed subject matter. In particular, FIG. 4 shows a side view of a DAC unit according to an embodiment of the present invention. As shown in FIG. 4, a process for capture of carbon dioxide from a gaseous feed stream 5 may include a direct air capture (DAC) unit 10. The DAC unit 10 may include an inlet air section 300, a sorbent section 310, and an outlet air section 320. The gaseous feed stream 5 may be received at the inlet air section 300. At least part of the gaseous feed stream 5 may be contacted with a sorbent material 40 that is located within the sorbent section 310. An exit gaseous outlet stream 60 may be provided from the outlet air section 320. As shown in FIG. 4, the DAC unit 10 may include more than one structural elements 410, for example, as shown, the DAC unit 10 may include two or more structural elements 410. According to an embodiment, the structural element 410 may be located within the inlet air section 300. As shown in FIG. 4, the structural elements 410 may be located in the inlet air section 300 extending from the top of the DAC unit 10 adjacent to the first and second inlet faces 20, 30. Furthermore, the structural elements 410 may be either partially or fully impermeable to the gaseous feed stream 5.

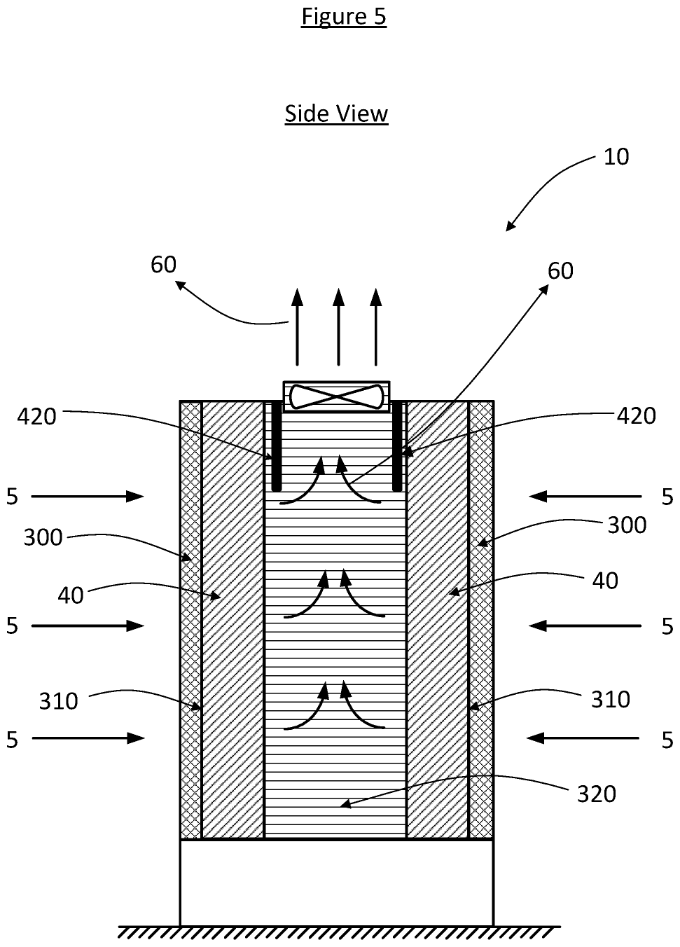

FIG. 5 shows an example process according to an implementation of the disclosed subject matter. In particular, FIG. 5 shows a side view of a DAC unit 10 according to an embodiment of the present invention. As shown in FIG. 5, a process for capture of carbon dioxide from a gaseous feed stream 5 may include a DAC unit 10. The DAC unit 10 may include an inlet air section 300, a sorbent section 310, and an outlet air section 320. The gaseous feed stream 5 may be received at the inlet air section 300. At least part of the gaseous feed stream 5 may be contacted with a sorbent material 40 that is located within the sorbent section 310. An exit gaseous outlet stream 60 may be provided from the outlet air section 320. As shown in FIG. 5, the DAC unit 10 may include more than one structural elements 420, for example, as shown, the DAC unit 10 may include two or more structural elements 420. According to an embodiment, and as shown in FIG. 5, the structural elements 420 may be located within the outlet air section 320. Furthermore, the structural elements 420 may be either partially or fully impermeable to the gaseous feed stream 5. Furthermore, the structural elements 420 may be either partially or fully impermeable to the exit gaseous outlet stream 60.

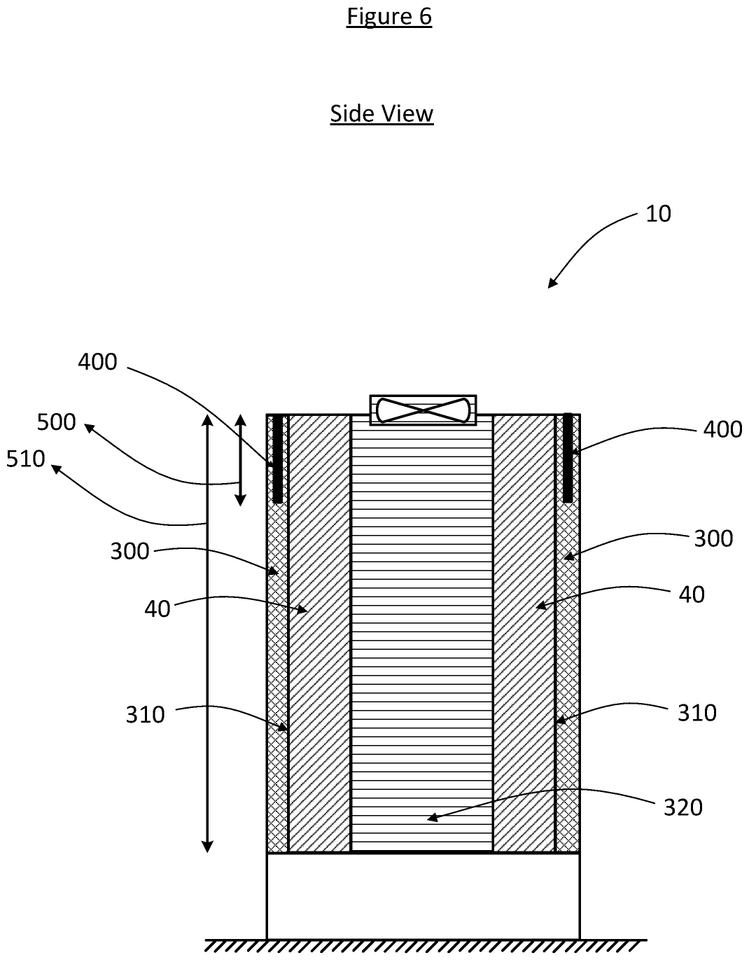

FIG. 6 shows an example process according to an implementation of the disclosed subject matter. In particular, FIG. 6 shows a side view of a DAC unit according to an embodiment of the present invention. As shown in FIG. 6, the DAC unit 10 may include an inlet air section 300, a sorbent section 310, and an outlet air section 320. FIG. 6 further shows a sorbent material 40 that is located within the sorbent section 310 and the DAC unit 10 may include two or more structural elements 400. According to an embodiment, the structural elements 400 may be located within the inlet air section 300. Further shown in FIG. 6, the DAC unit 10 may have a total height 510 and the structural elements 400 may have a length 500. According to an embodiment of the present invention, the ratio of the length 500 of the structural element 400 to the total height 510 of the DAC unit may be less than 0.3.

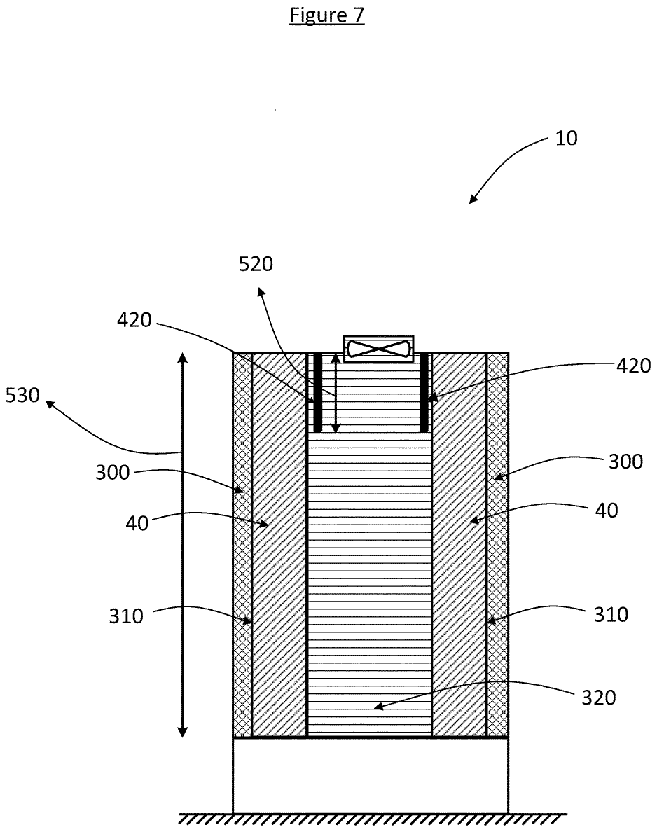

FIG. 7 shows an example process according to an implementation of the disclosed subject matter. In particular, FIG. 7 shows a side view of a DAC unit according to an embodiment of the present invention. As shown in FIG. 7, the DAC unit 10 may include an inlet air section 300, a sorbent section 310, and an outlet air section 320. FIG. 7 further shows a sorbent material 40 that is located within the sorbent section 310 and the DAC unit 10 may include two or more structural elements 420. According to an embodiment, the structural elements 420 may be located within the outlet air section 320. Further shown in FIG. 7, the DAC unit 10 may have a total height 530 and the structural elements 420 may have a length 520. According to an embodiment of the present invention, the ratio of the length 520 of the structural elements 420 to the total height 530 of the DAC unit may be less than 0.3.

### Examples

A commercially available, multi-physics modeling software StarCCM+ was used to compute the fluid flow patterns for the air flow inside the direct air capture unit. The length of the inlet faces was set at 12.19 m. The height of the DAC unit was set at 10.36 m. The direction of the incoming wind was set perpendicular to the two inlet faces of the unit. The total air flow rate through the module was fixed in all the examples. The following Table 1 shown below summarizes simulation results of different comparative examples according to implementations of the disclosed subject matter.

For each of the simulations, the wind direction was set to be perpendicular to the two inlet faces of the DAC unit. The air flow rate through each of the inlet faces was assumed to be equal. The sorbent thickness was set to be 0.5 m. Columns 2 and 3 in Table 1 compare the minimum and maximum volumetric flow rate of air through the sorbent section for different comparative examples. Column 4 in Table 1 shows the flow maldistribution across the entire sorbent for different comparative examples. Flow maldistribution was defined as the difference between the maximum air flow and the minimum air flow across the sorbent section, expressed as a percentage of the maximum air flow. Finally, column 5 in Table 1 is the sum of the pressure drop in the inlet air section and the outlet air section for different comparative examples.

### Base Case Example A was a DAC Unit with No Internal Floors in the Outlet Air Section

Comparative example 1 was a DAC unit similar to base case example A, except that it included two fully impermeable structural elements adjacent to the inlet faces and located in the inlet air section. As shown in Table 1, base case example A provided a flow maldistribution of 14.5% whereas comparative example 1 provided a flow maldistribution of 11.1%. This demonstrates that by including two fully impermeable structural elements adjacent to the inlet faces and located in the inlet air section, the DAC unit according to the disclosed subject matter provided improved (i.e., lower flow maldistribution) flow maldistribution since 11.1% (comparative example 1) is less than 14.5% (base case example A).

### Base Case Example B was a DAC Unit Similar to Base Case Example A, Except that it Included Solid Internal Floors in the Outlet Air Section

Comparative example 2 was a DAC unit similar to comparative base case example B, except that it included two partially impermeable structural elements adjacent to the inlet faces and located in the inlet air section. As shown in Table 1, base case example B provided a flow maldistribution of 27.6% whereas comparative example 2 provided a flow maldistribution of 14.8%. This demonstrates that by including two partially impermeable structural elements adjacent to the inlet faces and located in the inlet air section, the DAC unit according to the disclosed subject matter provided improved (i.e., lower flow maldistribution) flow maldistribution since 14.8% (comparative example 2) is less than 27.6% (base case example B). This also demonstrates that the present invention according to comparative example 2 achieved a minimum flow that is maintained to be within a range of 0-20% lower than the maximum flow over the entire sorbent section, i.e., a flow maldistribution of 14.8%. This was not the case for base case B which had a flow maldistribution of 27.6%, i.e., not within a range of 0-20% lower than the maximum flow over the entire sorbent section.

Comparative example 3 was a DAC unit similar to base case example B except that it further included a fully impermeable structural element located in the outlet air section. As shown in Table 1, base case example B provided a flow maldistribution of 27.6% whereas comparative example 3 provided a flow maldistribution of 8.3%. This demonstrates that by including two fully impermeable structural elements located in the outlet air section, the DAC unit according to the disclosed subject matter provided improved (i.e., lower flow maldistribution) flow maldistribution since 8.3% (comparative example 3) is less than 27.6% (base case example B). This also demonstrates that the present invention according to comparative example 3 achieved a minimum flow that is maintained to be within a range of 0-20% lower than the maximum flow over the entire sorbent section, i.e., a flow maldistribution of 8.3%. This was not the case for base case B which had a flow maldistribution of 27.6%, i.e., not within a range of 0-20% lower than the maximum flow over the entire sorbent section.

In summary, as demonstrated and shown in columns 3 and 4 in Table 1, comparative examples 1, 2 and 3 achieved flow maldistribution less than 20%. All the comparative examples had less than 200 Pa pressure drop across the inlet and the outlet air sections demonstrating the results achieved by the disclosed subject matter.

Furthermore, the results and effects of the present invention are demonstrated by comparing results from the various comparative examples as provided in Table 1 below. The addition of fully impermeable structural units (e.g., comparative example 1) or partially impermeable structural elements (comparative example 2) in the inlet air section adjacent to the inlet faces led to less flow maldistribution. Moreover, including a fully impermeable structural element located in the outlet air section (comparative example 3) also led to lower flow maldistribution.

Table 1 below shows the minimum and maximum air flow rate through the sorbent section (hence, the flow maldistribution) and the pressure drop across the inlet and outlet air sections for the different examples according to various embodiments of the disclosed invention. Flow maldistribution is the difference between the minimum and the maximum air flow rate through the sorbent section, expressed as a percentage of the maximum air flow rate.

| | | | Flow | Pressure drop |
|---|---|---|---|---|
| | Minimum | Maximum | maldistribution | across the inlet |
| | flow | flow | % (1 − min flow/ | and outlet air |
| Example | (m³/s) | (m3/s) | max flow)*100 | section |
| Base case | 28.1 | 32.9 | 14.5 | 84.3 |
| example A | | | | |
| Comparative | 28.8 | 32.4 | 11.1 | 87.0 |
| example 1 | | | | |
| Base case | 25.7 | 35.5 | 27.6 | 95.3 |
| example B | | | | |
| Comparative | 28.2 | 33.1 | 14.8 | 84.6 |
| example 2 | | | | |
| Comparative | 28.8 | 31.4 | 8.3 | 88.1 |
| example 3 | | | | |

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A process for capture of carbon dioxide from a gaseous feed stream, the process comprising:
a) a direct air capture (DAC) unit comprising:
1) an inlet air section,
2) a sorbent section, and
3) an outlet air section,
b) receiving a gaseous feed stream at the inlet air section,
c) contacting at least part of the gaseous feed stream with a sorbent material located within the sorbent section,
d) providing an exit gaseous outlet stream from the outlet air section,
wherein the total pressure loss across the inlet and outlet air sections is maintained at less than 200 Pa;
wherein the gaseous feed stream has a volumetric flow within the sorbent section and the volumetric flow has a maximum flow and a minimum flow, and
wherein the DAC unit further comprises at least one structural element for maintaining the minimum flow to be within a range of 0-20% lower than the maximum flow over the entire sorbent section.

2. The process for capture of carbon dioxide from a gaseous feed stream according to claim 1, wherein the direct air capture (DAC) unit further comprises:
1) a first inlet face and a second inlet face, wherein the first and second inlet faces are on opposite sides of the DAC unit within the inlet air section, wherein the sorbent material is located at or behind each of the first and second inlet faces; and
2) an outlet located at the top of the DAC unit within the outlet air section for providing the exit gaseous outlet stream, and wherein the exit gaseous outlet stream has a flow that is produced by at least one fan;
wherein the gaseous feed stream is received at each of the first and second inlet faces, wherein the gaseous feed stream has an average CO2 concentration greater than 95% of the CO2 concentration of ambient air by minimizing reingestion of the exit gaseous outlet stream, and wherein the ambient air has any wind direction and any wind speed.

3. The process for capture of carbon dioxide from a gaseous feed stream according to claim 1, wherein gaseous feed stream is accelerated one time in the inlet air section and wherein the exit gaseous outlet stream is accelerated one time in the outlet air section.

4. The process for capture of carbon dioxide from a gaseous feed stream according to claim 1, wherein the at least one structural element is located in the inlet air section extending from the top of the DAC unit adjacent to at least one of the first and second inlet faces, and wherein the structural element is either partially or fully impermeable to the gaseous feed stream.

5. The process for capture of carbon dioxide from a gaseous feed stream according to claim 4, wherein the structural element has a length, and wherein the ratio of the length of the structural element to the total height of the DAC unit is less than 0.3.

6. The process for capture of carbon dioxide from a gaseous feed stream according to claim 1, wherein the at least one structural element is located in the outlet air section, and wherein the structural element is either partially or fully impermeable to the exit gaseous outlet stream.

7. The process for capture of carbon dioxide from a gaseous feed stream according to claim 6, wherein the structural element has a length, and wherein the ratio of the length of the structural element to the total height of the DAC unit is less than 0.3.
